(19) United States
(12) Patent Application Publication
(10) Pub. No.: US 2004/0109795 A1
(43) Pub. Date: Jun. 10, 2004

(54) Cleanable device for depolluting an engine exhaust gases

(76) Inventor: Bertrand Marc, Courcelles-Les-Montbeliard (FR)

Correspondence Address: YOUNG & THOMPSON, 745 SOUTH 23RD STREET 2ND FLOOR, ARLINGTON, VA, 22202

(21) Appl. No.: 10/468,449

(22) PCT Filed: Feb. 20, 2002
(86) PCT No.: PCT/FR02/00641

(30) Foreign Application Priority Data
Feb. 21, 2001 (FR) 01/02354

(51) Int. Cl. B01D 53/34

(52) U.S. Cl. 422/177; 422/171

(57) ABSTRACT

A device for depolluting a heat engine exhaust gases includes an outer casing (23) defining a passage for the circulation of exhaust gases and, mounted in series in the passage, a catalytic purifying member (18) and a particulate filter (20). The casing (23) includes a transverse break (34) along its entire periphery, which break (34) divides the casing (23) into successive sections (38, 40), the device including a detachable device (36) connecting two successive sections along the break. The detachable connecting device (36) extends in a plane transverse to the gas circulation passage and passes through either the catalytic purifying member (18) or the particulate filter (20).

The present invention relates to a device for depollution of the exhaust gases from a heat engine, of the type comprising an outer casing delimiting a passage for circulation of the exhaust gases and, mounted in series in the said passage, a catalytic purification unit and a particulate filter, the said casing having a transverse break along its entire periphery which separates the casing into successive sections, the device comprising detachable means for connection of the two successive sections along the said break.

Such devices are used in particular for the depollution of diesel engines of automobiles. The catalytic purification unit is adapted for the treatment of the polluting emissions in the gaseous phase, whilst the particulate filter is adapted to trap the soot particles emitted by the engine.

The particulate filter operates according to a succession of filtration and regeneration phases. During the filtration phases the soot particles emitted by the engine are deposited on the upstream face of the filter. During the regeneration phase the soot particles, composed essentially of carbon, are burnt on the upstream face of the filter in order to restore its original properties.

In order to encourage the regeneration of the particulate filter, it is necessary to incorporate into the fuel supplied to the engine a chemical agent which lowers the combustion temperature of the soot. This chemical agent is a catalytic additive containing one or several metal constituents in the form of organometallic compounds. These are burnt in the combustion chamber of the engine and are deposited in the form of oxides within the soot particles on the upstream face of the particulate filter.

During the regeneration phases of the particulate filter, the metal oxide residues, commonly called ash, are retained on the upstream face of the particulate filter. Thus during prolonged use of the depollution device the accumulation of ash substantially reduces the properties of the particulate filter and in particular its ability to be regenerated. For a depollution device installed on a vehicle with a diesel engine, a reduction in the properties of the particulate filter is noted after 50,000 km.

The patent application FR-98-15773 describes a device for depollution of the exhaust gases in which the means for access to the upstream face of the particulate filter include a break in the casing associated with detachable means for connection of two successive sections of the casing.

The break in the envelope is formed in the free gap provided between the catalytic purification unit and the particulate filter. The detachable connection means, formed by a set of bolts passing through flat flanges, are also disposed around the free gap defined in the casing.

A gasket is interposed between the two flanges in order to ensure satisfactory sealing.

Such a gasket necessitates high heat stability of the connection between the two successive sections.

Thus the detachable connection means must be disposed in the gap between the catalytic purification unit and the particulate filter. This arrangement leads to a relatively substantial axial dimension of the outer casing of the depollution device.

The object of the invention is to propose a depollution device of reduced dimensions, particularly having a reduced length measured along the axis of the passage for circulation of the exhaust gases.

In order to achieve this object, the invention relates to a device for depollution of the exhaust gases from a heat engine, of the aforementioned type, characterised in that the said detachable connection means extend in a plane extending transversely with respect to the circulation passage and passing through one of the catalytic purification device and of the particulate filter.

According to particular embodiments, the depollution device includes one or several of the following characteristics:

the two successive sections have ends which are engaged in one another and overlap along a part of the length of the circulation passage;

the end of the upstream section, viewed in the normal direction of flow in the circulation passage, extends inside the end of the downstream section when viewed in the normal direction of flow in the circulation passage;

the said detachable connection means extend around the said catalytic purification unit;

the two associated ends of two successive sections have complementary profiles in the shape of truncated cones for centring;

the said detachable connection means have a peripheral flange integral with each section and a strap encircling the two flanges and ensuring axial clamping of the flanges against one another;

at least one of the peripheral flanges is formed by deformation of the section of casing;

at least one of the peripheral flanges has an attached ring around the said associated section of casing;

it has an O ring interposed between the two flanges;

the said strap has at least one profile delimiting a channel inside which the two flanges and a clamping collar surrounding the or each profile are gripped; and

one of the flanges extends at a distance from the end of the associated section of casing along the length of the passage for flow of the exhaust gases.

The invention will be better understood upon reading the following description which is given solely by way of example and with reference to the accompanying drawings, in which:

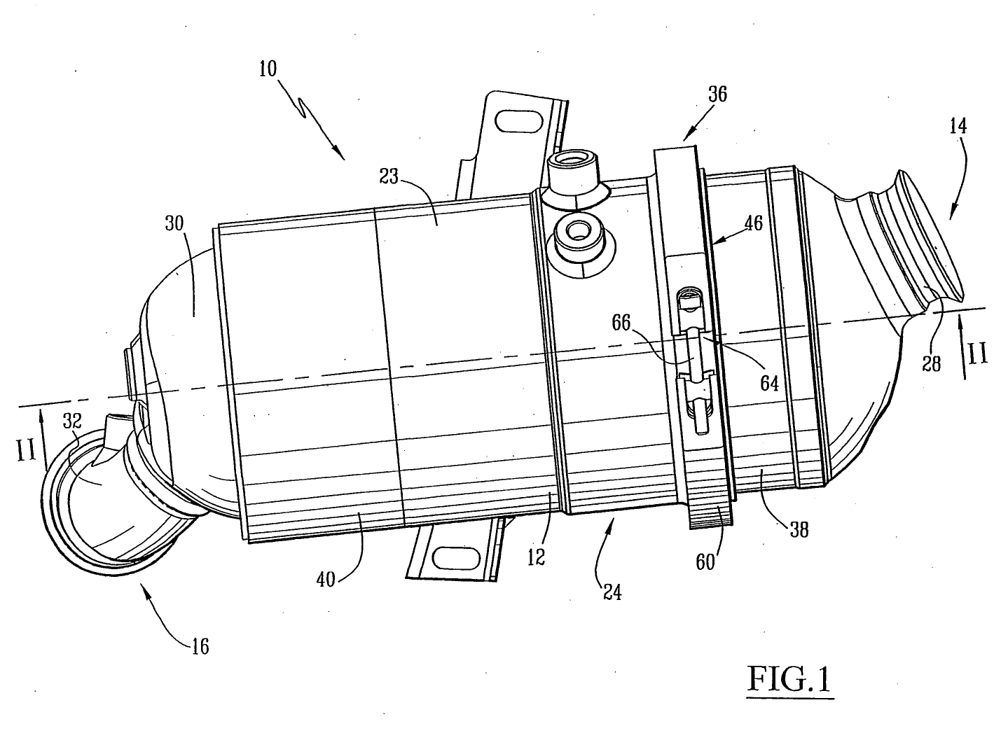

FIG. 1 is a view in elevation of a device for depollution of the exhaust gases according to the invention;

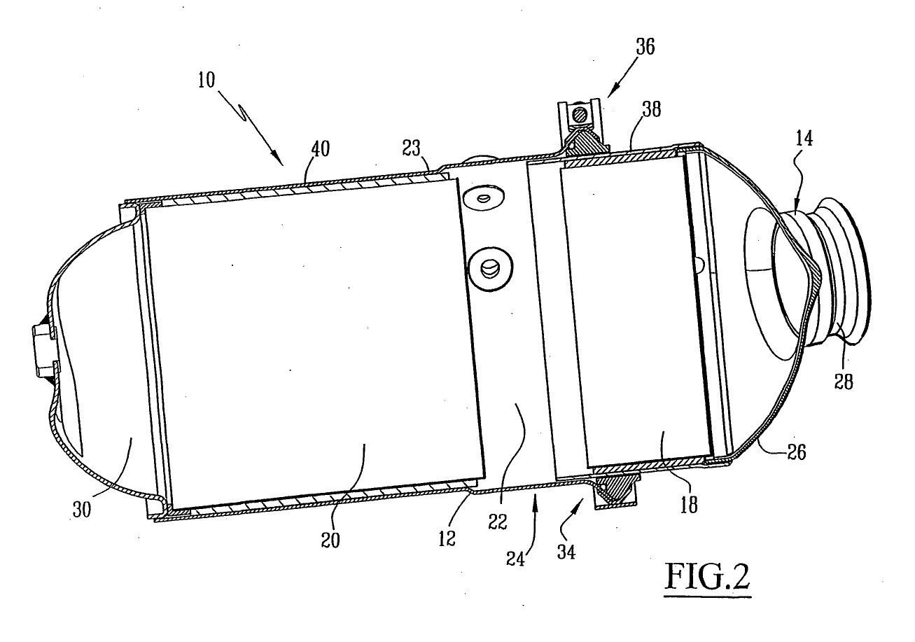

FIG. 2 is a longitudinal sectional view along the line II-II of the depollution device of FIG. 1;

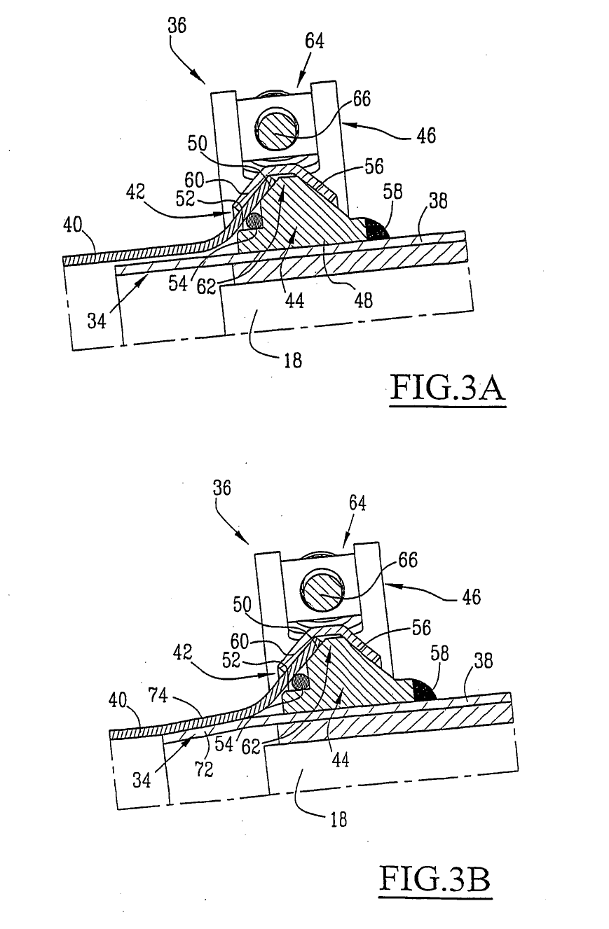

FIG. 3A is a view on a larger scale of a detail of the means for connection of the two successive sections of the depollution device of FIGS. 1 and 2;

FIG. 3B is a view similar to that of FIG. 3A of a variant of the connection means;

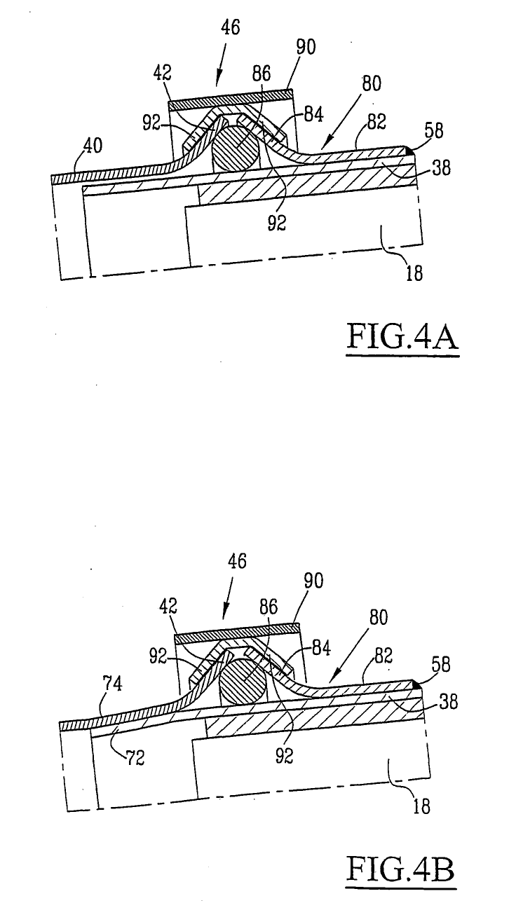

FIGS. 4A and 4B are identical views to those of FIGS. 3A and 3B of two variants of a different embodiment of the connection means; and

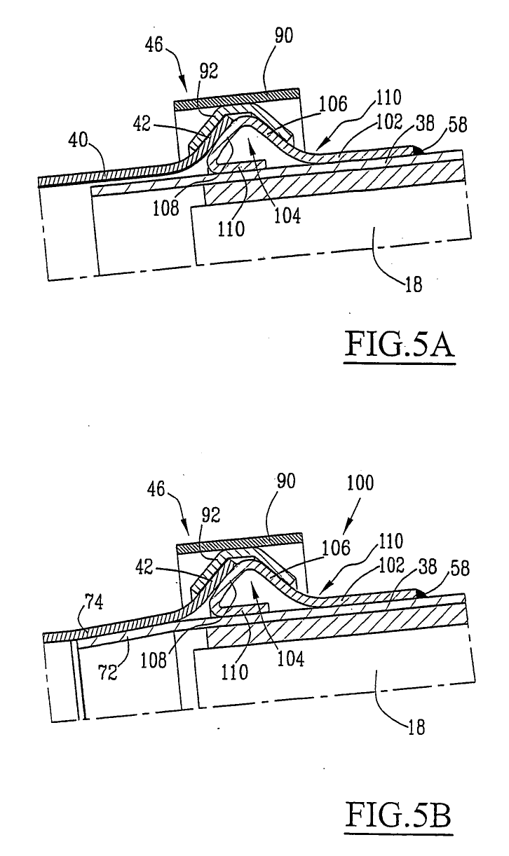

FIGS. 5A and 5B are identical views to those of FIGS. 4A and 4B of two variants of yet another embodiment of the connection means.

The depollution device 10 shown in FIGS. 1 and 2 comprises a generally cylindrical silencer 12 having an inlet 14 at one end and an outlet 16 at its other end. A catalytic purification unit 18 and a particulate filter 20 which are separated by a free transitional space 22 are disposed successively from the inlet towards the outlet inside the silencer 12.

The silencer 12 comprises an outer casing 23 delimiting a passage for circulation of the exhaust gases through which the catalytic purification unit 18 and the particulate filter 20 are disposed.

The catalytic purification unit 18 consists, for example, of a gas-permeable structure covered with catalytic metals which promote oxidation of the combustion gases and/or reduction of the nitrogen oxides.

The particulate filter 20 is produced from a filtration material consisting of a monolithic structure made from ceramic or from silicon carbide having sufficient porosity to permit the passage of the exhaust gases. However, as is known per se, the diameter of the pores is chosen to be sufficiently small to ensure that the particles, and particularly the soot particles, are trapped on the upstream face of the filter. The particulate filter can equally be produced from a ceramic or silicon carbide foam. It can also consist of a cartridge filter or a sintered metal filter.

The particulate filter used here has for example a set of parallel channels distributed in a first group of inlet channels and a second group of outlet channels The inlet and outlet channels are disposed so that they are staggered.

The inlet channels open onto the upstream section of the particulate filter and are closed off at the level of the downstream section of the particulate filter.

By contrast, the outlet channels are closed off on the upstream section of the particulate filter and open onto the downstream section thereof.

In its common part the outer casing is formed by a cylindrical wall 24 of substantially constant cross-section.

At its inlet end, the silencer has a divergent section 26 connecting an inlet pipe 28 to the cylindrical wall 24. Equally, at its rear end, the cylindrical wall 24 is extended by a convergent section 30 ending in an outlet pipe 32 delimiting the outlet 16.

In operation, the exhaust gases first of all circulate through the catalytic purification unit 18 then through the particulate filter 20.

Means for access to the upstream surface of the particulate filter 20 are provided along the length of the casing 23. They include a transverse break 34 in the casing of the silencer along its entire periphery and detachable means 36 for connection of the two successive sections 38, 40 thus defined in the cylindrical wall 24 on either side of the break 34.

According to the invention, the detachable connection means 36 are disposed in a plane extending transversely with respect to the circulation passage and passing through one of the catalytic purification unit 18 and the particulate filter 20.

In the illustrated embodiment, the detachable connection means 36 extend around the catalytic purification unit 18.

More precisely, and as illustrated in FIG. 3A, the detachable connection means extend at a distance from the end of the section of casing 38, the end of which is fitted inside the corresponding end of the section of casing 40.

Thus the ends of the sections of casing 38 and 40 overlap one another, the end of the upstream section 38, when viewed in the normal direction of flow in the circulation passage, extending inside the end of the downstream section 40.

Advantageously, the detachable connection means comprise a peripheral flange 42, 44 integral with each section of casing 38, 40. They also comprise a peripheral strap 46 gripping the two flanges 42, 44 and stressing these against one another along the axis of the passage for circulation of the exhaust gases.

Advantageously, the flange 42 formed at the end of the downstream section 40 consists of a collar obtained by deformation towards the exterior of the cylindrical wall delimiting the downstream section of casing 38. This flange has the general shape of a truncated cone and widens progressively towards the open end of the downstream section 40.

The flange 44 is formed by a ring 48 attached around the upstream section 38. This ring is machined and has a toroidal shape with a constant, generally triangular cross-section. It has a face which bears on the external surface of the section 38. A chamfer 50 for support of the flange 42 is produced on its flank turned towards the end of the downstream section 40. This chamfer is grooved by a shoulder 52 delimiting an annular recess for receiving an O ring 54. The chamfer has an identical inclination to that of the flange 42.

On its flank opposite the downstream section 40, the ring 48 has a chamfer 56 of which the inclination is opposed to the chamfer 50. The ring 48 is joined to the upstream section of casing 38 by a peripheral weld bead 58. It is welded away from the free end of the upstream section 38.

The strap 46 includes a clamping band 60 encircling the two flanges 42 and 44. This clamping band has the general shape of a V delimiting a channel 62 in which the two flanges are retained. Each of the lateral flanks of the channel has an inclination corresponding to that of the flange 42 and of the chamfer 56 of the complementary flange 44.

The band 60 forms an open loop of which the two ends are connected to one another by a tensioning mechanism 64 comprising for example a tightening screw 66. This screw ensures that the two ends of the band 60 are brought closer together.

It will be understood that with such a device, after a predetermined period of operation of the engine, when the upstream face of the particulate filter is soiled with ash it is possible to intervene on the vehicle in order to clean the particulate filter.

For this purpose the device 10 is first of all removed from the exhaust line of the vehicle. The two successive sections 38, 40 are separated by release of the tensioning mechanism 64, this release enabling the strap 46 to be removed. The opening of the casing along the transverse break 34 permits access to the upstream face of the particulate filter 20, this face being turned towards the purification unit 18.

A nozzle for injection of air or of a suitable fluid is applied downstream of the particulate filter. Under the action of the air or the fluid circulating in countercurrent through the particulate filter, the ash retained on the upstream surface of the filter is removed.

After cleaning of the upstream face of the particulate filter, the two sections of the device are reassembled and the strap 46 is put back in place. The device is then re-installed in the exhaust line of the vehicle.

The following figures show other embodiments of the means for connection of the two successive sections, as well as variants of these different embodiments.

In these figures the elements which are identical or analogous to those of FIG. 3A are designated by the same reference numerals.

In the embodiment of FIG. 3B, the profiles of the successive sections 38 and 40 are modified.

In particular, these sections have at their coupled ends complementary profiles in the shape of truncated cones 72, 74 ensuring centring of the two successive sections with respect to one another during the installation of the silencer.

The open end of the upstream section 38 has an external diameter which decreases progressively from the flange 44 to its free end.

Thus a surface in the shape of a truncated cone forming a Morse taper is formed at the end of the section 38, the inclination of this truncated cone surface being between 1° and 6°.

A corresponding surface in the shape of a truncated cone widening progressively towards the open end is provided on the downstream section 40 behind the flange 42.

It will be understood that during the fitting of the upstream section 38 in the downstream section 40, the presence of the two surfaces in the shape of truncated cones 72, 74 with complementary surfaces ensures satisfactory centring of the two successive sections along the longitudinal axis of the passage for the gases in the casing.

Furthermore, the application of the surfaces 72, 74 against one another forms a leak-tight barrier preventing the flow of the exhaust gases out of the casing at the level of the break 34.

In the embodiment of FIG. 4A, the downstream section 40 is identical to that of FIG. 3A.

By contrast, the ring 48 of FIG. 3A is replaced by a sleeve 80 attached around the outer surface of the upstream section 38 and welded thereto.

The sleeve 80 is formed by a ferrule having a cylindrical portion 82 extended towards the open end of the upstream section 38 by a portion in the shape of a truncated cone 84 forming a flange. This portion in the shape of a truncated cone 84 moves away progressively towards its end of the generally cylindrical wall forming the upstream section 38.

An O ring 86 is confined between the flanges 82 and 84, this ring being applied against the outer lateral surface of the upstream section 38.

This O-ring 86 is formed for example by a stainless steel tube filled with a wire mesh.

In this embodiment the strap 46 comprises, on the one hand, an outer flexible band 90 and, on the other hand, a plurality of rigid troughs 92. These rigid troughs have a generally arched shape following external curvature of the casing. They have a generally C-shaped cross-section and have two lateral flanks adapted so as to be applied on the outer surfaces of the flanges 42 and 84.

The flexible band 90 s applied on the outer periphery of the troughs 92 ensuring that they lie flat on the flanges 42 and 84.

The band 90 has clamping means (not shown) which ensure that its two ends are brought closer together.

It will be understood that, under the action of the flexible band 90 encircling the troughs 92, these latter lie flat against the outer surfaces of the flanges 42, 84. By a cam effect the two flanges 42, 84 are brought closer to one another following the direction of the axis of circulation of the gases in the envelope. Thus the flanges lie flat on the O ring 86, this latter being compressed against the outer surface of the upstream section 38.

In the variant illustrated in FIG. 4B, the successive sections 38 and 40 have complementary centring profiles formed, as in the embodiment of FIG. 3B, by portions in the shape of a truncated cone forming complementary Morse tapers.

In the embodiment of FIG. 5A, the sleeve 80 and the ring 86 are replaced by one and the same sleeve 100. This is welded onto the outer surface of the upstream section 38. It has a cylindrical portion 102 followed towards the open end of the section 38 by a bead 104 forming a flange. This bead has a portion in the shape of a truncated cone 106 extending the cylindrical portion 102 by moving progressively away from the generally cylindrical wall of the upstream section. This portion widening towards the free end of the upstream section 38 is extended towards this end by a convergent portion in the shape of a truncated cone 108. This truncated cone surface moves progressively closer to the lateral wall of the upstream section 38 in the direction of its free end.

The inclination of the portion in the shape of a truncated cone 10 is identical to the inclination of the flange 42 provided at the end of the downstream section 40. Finally, the sleeve 100 is extended beyond the convergent portion 108 forming a flange by a cylindrical bearing surface 110 bent back against the outer lateral surface of the upstream section 38 below the bead 104 delimited by the surfaces in the shape of truncated cones with opposing inclination 106 and 108.

As in the preceding embodiment, the strap 46 has an assembly of rigid troughs 92 and a flexible band 90 griping these troughs around the flanges of the two successive sections.

In the embodiment of FIG. 5B, the successive sections also have complementary centring surfaces in the shape of truncated cones 70, 72.

In each of the embodiments, the detachable connection means 36 extend around one of the catalytic purification unit and the particulate filter. Thus the free transitional space 22 can be reduced. Furthermore, since the connection is formed around an element extending in the passage for circulation of the gases, the solidity of the connection and its leak-tightness are improved.

1. Device for depollution of the exhaust gases from a heat engine comprising an outer casing (23) delimiting a passage for circulation of the exhaust gases and, mounted in series in the said passage, a catalytic purification unit (18) and a particulate filter (20), the device comprising means for access to the upstream surface of the particulate filter, these access means comprising a transverse break (34) in the casing along its entire periphery, which break (34) separates the casing (23) into successive sections (38, 40), the device further comprising detachable means (36) for connection of the two successive sections along the said break, characterised in that the said detachable connection means (36) extend in a plane extending transversely with respect to the circulation passage and passing through one of the catalytic purification device (18) and of the particulate filter (20).

2. Device as claimed in claim 1, characterised in that the two successive sections (38, 40) have ends which are engaged in one another and overlap along a part of the length of the circulation passage.

3. Device as claimed in claim 2, characterised in that the end of the upstream section (38), viewed in the normal direction of flow in the circulation passage, extends inside the end of the downstream section (40) when viewed in the normal direction of flow in the circulation passage.

4. Device as claimed in any one of the preceding claims, characterised in that the said detachable connection means (36) extend around the said catalytic purification unit (18).

5. Device as claimed in any one of the preceding claims, characterised in that the two associated ends of two successive sections (38, 40) have complementary profiles in the shape of truncated cones for centring (72, 74).

6. Device as claimed in any one of the preceding claims, characterised in that the said detachable connection means (36) have a peripheral flange (42, 44; 80; 104) integral with each section (38, 40) and a strap (46) encircling the two flanges (42, 44; 80; 104) and ensuring axial clamping of the flanges against one another.

7. Device as claimed in claim 6, characterised in that at least one (42) of the peripheral flanges is formed by deformation of the section of casing (40).

8. Device as claimed in claim 6 or 7, characterised in that at least one of the peripheral flanges has an attached ring (48; 80; 104) around the said associated section of casing (38).

9. Device as claimed in any one of claims 6 to 8, characterised in that it has an O ring (54; 86) interposed between the two flanges (42, 44; 80).

10. Device as claimed in any one of claims 6 to 9, characterised in that the said strap (46) has at least one profile (92) delimiting a channel inside which the two flanges and a clamping collar (90) surrounding the or each profile (82) are gripped.

11. Device as claimed in claim 2 or 3 and any one of claims 2 to 10, characterised in that one of the flanges (44; 80; 104) extends at a distance from the end of the associated section of casing (38) along the length of the passage for flow of the exhaust gases.
